(19) United States
(12) Patent Application Publication
(10) Pub. No.: US 2025/0203360 A1
(43) Pub. Date: Jun. 19, 2025

(54) TAMPER-PROOF EVENT LOGGING FOR OPEN-RADIO ACCESS NETWORKS (O-RANs)

(71) Applicant: Fujitsu Limited, Kawasaki-shi (JP)

(72) Inventor: Shahriar EMAMI, Newark, CA (US)

(73) Assignee: Fujitsu Limited, Kawasaki-shi (JP)

(21) Appl. No.: 18/541,655

(22) Filed: Dec. 15, 2023

(51) Int. Cl. H04W 12/06; H04W 12/043; H04W 12/10

(52) U.S. Cl. CPC H04W 12/06; H04W 12/043; H04W 12/10

(57) ABSTRACT

In an embodiment, operations include detecting a first event log associated with a first network component of an open-radio access network (O-RAN). The operations further include generating a first digest associated with the first event log. The operations further include generating a first encrypted digest from the first digest based on application of the first encryption key on the first digest. The operations further include generating first log information associated with the first network component, based on the first event log and the first encrypted digest. The operations further include transmitting the first log information to a service management component of the O-RAN for validation of an authenticity of the first event log based on the first encrypted digest. The operations further include controlling a first display device to render the first log information based on authenticity of the first event log.

### FIELD

The embodiments discussed in the present disclosure are related to tamper-proof event logging for open-radio access networks (O-RANs).

### BACKGROUND

Advancements and evolution in networking and telecommunication systems have led to emergence of open-radio access network (O-RAN) technology that facilitates decentralization of network infrastructure and introduces interoperability between network components associated with different vendors. The decentralization may be actualized based on virtualization of integrated legacy radio access networks into open, modular, and interoperable components. The virtualization may involve disaggregation of the legacy radio access networks based on functionality such that disaggregated components (such as radio units, distributed units, or centralized units) of a virtual radio access network may be managed using intelligent controllers and connected to each other via standardized open interfaces. The disaggregation may facilitate adoption of innovation, optimization, and development in both hardware and software associated with components of a fifth generation (5G) network and building a 5G network with a greater flexibility and scalability compared to a proprietary 5G random access network. The disaggregated radio access networks (i.e., ORANs) may enable actualization of cost-effective network deployment in small cells and improve network efficiency.

However, network disaggregation, usage of open-interfaces, and adoption of non-proprietary solutions may pose unprecedented challenges in ensuring security and countering threats/attacks on the O-RAN components and user data that may be stored in the O-RAN. The attacks may compromise availability of O-RAN infrastructure, which may be due to an unauthorized access to one or more disaggregated O-RAN components or insertion of inauthentic logs in depositories associated with the disaggregated O-RAN components. Such attacks may degrade or deteriorate performance of the O-RAN.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include a set of operations, which may include detecting a first event log associated with a first network component of an open-radio access network (O-RAN). The set of operations may further include generating a first digest associated with the first event log. The set of operations may further include applying a first encryption key on the first digest associated with the first event log. The set of operations may further include generating a first encrypted digest from the first digest based on the application of the first encryption key on the first digest. The set of operations may further include generating first log information associated with the first network component. The generation may be based on the first event log and the first encrypted digest. The set of operations may further include transmitting the first log information to a service management component of the O-RAN. The service management component may validate, based on the first encrypted digest, an authenticity of the first event log. The set of operations may further include controlling a first display device to render the first log information based on the authenticity of the first event log.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example network environment related to tamper-proof event logging in open-radio access networks (O-RANs);

FIG. 2 is a block diagram that illustrates an exemplary electronic device for facilitating tamper-proof event logging in O-RANs;

FIG. 3 is a diagram that illustrates an exemplary execution pipeline for facilitating tamper-proof event logging in O-RANs;

FIG. 4 is a diagram that illustrates an exemplary architecture of an O-RAN; and

FIG. 5 is a diagram that illustrates a flowchart of an example method for facilitating tamper-proof event logging in O-RANS;

all according to at least one embodiment described in the present disclosure.

### DESCRIPTION OF EMBODIMENTS

Some embodiments described in the present disclosure relate to methods and systems for ensuring of tamper-proof event logging for open-radio access networks (O-RANs). Herein, ensuring tamper-proof event logging may involve detection of a first event log that may be associated with a first network component of the O-RAN. Once the first event log is detected, a first digest associated with the first event log may be generated by use of a digest generator. Thereafter, a first encryption key may be applied on the first digest associated with the first event log. Based on the application of the first encryption key on the generated first digest a first encrypted digest may be generated from the generated first digest. After the generation of the first encrypted digest, first log information associated with the first network component may be generated. The generation of the first log information may be based on the first event log and the first encrypted digest. The first log information may be transmitted to a service management component of the O-RAN. The service management component of the O-RAN may be configured to validate, based on the first encrypted digest, an authenticity of the first event log. Finally, rendering of the first log information, on a first display device, may be controlled based on the authenticity of the first event log.

An O-RAN architecture may be a distributed network architecture that may include disaggregated radio access network components (for example, distributed units, centralized units, radio units, and so on). The network components of the O-RAN may be connected to each other via O-RAN open interfaces (for example, E2 interface, O1 interface, A1 interface, and so on). The open interfaces may be used to connect network components with controllers (such as, radio access network intelligent controllers) that may optimize, deploy control actions and policies, stream telemetry, and so on, via the open interfaces. Therefore, an O-RAN may support modularity and interoperability between hardware/software associated with the network components manufactured by different vendors. This may enable cloudification and virtualization of a legacy radio access network, simplify network management and maintenance, and reduce cost. The disaggregation of the radio access network components may enable creation of flexible and scalable networks that have greater agility and resiliency, are adaptive to innovations, and whose dependency on proprietary solutions is significantly reduced.

However, deployment of an O-RAN architecture may introduce significant security challenges for mobile network operators due to the disaggregation of network components and introduction of additional complexity due to incorporation of network components from multiple vendors. The security challenges may be further enhanced due to vulnerability of attacks on the open interfaces, usage of non-proprietary solutions (hardware/software that may originate from multiple vendors), and so on. Some of the security challenges facing the deployment of O-RANs may include compromising of one or more of an integrity and confidentiality of user data, integrity of O-RAN infrastructure, or an availability of the O-RAN infrastructure. These attacks may take place due to unauthorized access to disaggregated radio access network, malicious deployment of applications, usage of compromised software, misconfiguration of the open interfaces, unregulated access to user data, and so on. One of the primary security challenges that may contribute to the abovementioned security challenges may be introduction of fake-logs in a depository of a service management component of the O-RAN. Creation of fake log entries or records may be a security threat that may lead to denial-of-service attacks. Such an attack may degrade or deteriorate the overall performance of the O-RAN and lead to creation of conflict between applications.

According to one or more embodiments of the present disclosure, the technological field of event logging for O-RAN may be improved by configuring or designing computing systems, i.e., a secure logging system, that may be included in network components of an O-RAN. The improvements of the event logging for O-RAN may be such that the computing systems may ensure integrity or authenticity of logs that may be included in depositories of the network component (for example, an electronic device) during occurrences of one or more events in the network components. A computing system of a service management component (such as, a service management and orchestration (SMO) component) of the O-RAN may be enabled to detect fake log records or entries that may be added in the depositories of certain network components such as, a radio unit (RU) component, a centralized unit (CU) component, a distributed unit (DU) component, a near real-time radio intelligent controller (near-RT RIC) component, and so on. The computing system of the SMO may identify, from log information associated with an event log, detected by one of the abovementioned network components (i.e., the RU, CU, DU, near-RT RIC, and so on) of the O-RAN when the detected event log is added or registered. The detection of fake logs and identification of a network component (i.e., the RU, CU, DU, near-RT RIC, and so on) in which a fake log is registered, may enable avoidance of fake log entries in the network component and improve security of the O-RAN architecture. The secure logging system (i.e., the computing system of the SMO) may monitor, identify, or prevent inclusion or registration of fake logs. For such detection of fake logs and identification of network component in which a log is registered, the computing system of the SMO may be required to receive log information, from the networking components (i.e., the RU, CU, DU, near-RT RIC, and so on) of the O-RAN, that may be encrypted using cryptographic keys.

Each network component (i.e., the RU, the DU, the CU, or the near-RT RIC) of the O-RAN may include a computing system (i.e., a logging system) that may be designed to prevent inclusion or ensure deletion of fake or tampered event logs in the corresponding network component. The computing system of each network component may be configured to receive a cryptographic key from a key-delivery component of the O-RAN. The received cryptographic key may be used for generation of log information on registration/inclusion of an event log in the corresponding network component. Once the registration/inclusion of the event log in the corresponding network component is detected, a digest of the event log may be generated. The digest may be subsequently encrypted using the cryptographic key for generation of an encrypted digest. The encrypted digest may be concatenated with the event log for generation of the log information. The computing system of the service management component (i.e., the SMO) may receive the log information and verify or validate an integrity or authenticity of the event log based on the cryptographic key and the encrypted digest included in the received log information. After the verification or validation, the computing system of the service management component may stream an authentication result to a security component (such as, a security information and event management (SIEM) component) of the O-RAN. The security component may execute appropriate actions based on the authentication result to prevent denial-of-service attacks on the O-RAN.

Embodiments of the present disclosure are explained with reference to the accompanying drawings.

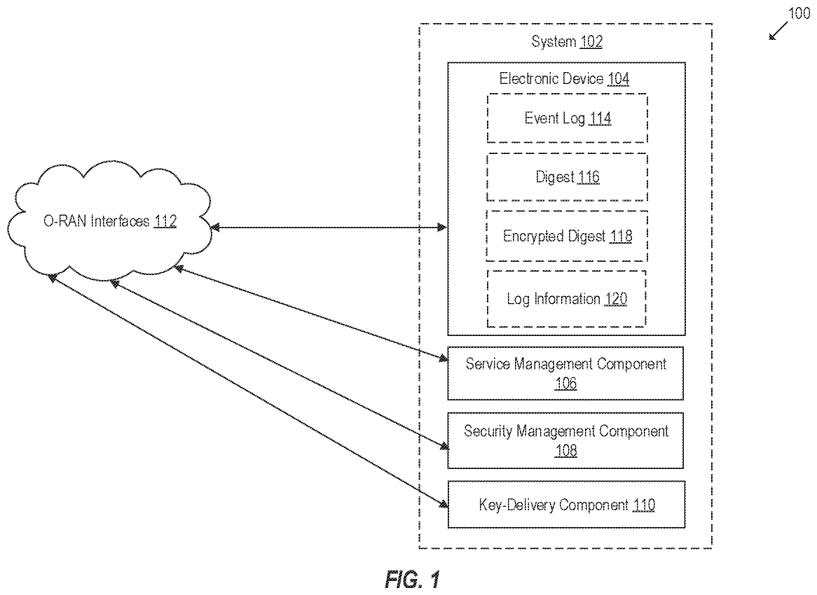

FIG. 1 is a diagram representing an example network environment related to tamper-proof event logging in open-radio access networks (O-RANs), according to at least one embodiment described in the present disclosure. With reference to FIG. 1, there is shown a network environment 100. The network environment 100 may include a system 102 that may include a portion of an O-RAN. The system 102 may include disaggregated radio access network components, such as, an electronic device 104, a service management component 106, a security management component 108, and a key-delivery component 110. The electronic device 104, the service management component 106, the security management component 108, the key-delivery component 110, and other network components (not shown) of the O-RAN may be coupled to each other communicatively, via an O-RAN interfaces 112. In FIG. 1, there is further shown, an event log 114, a digest 116, an encrypted digest 118, and log information 120, associated with the electronic device 104.

The electronic device 104 may include suitable logic, circuitry, interfaces, and/or code that may be configured to detect the event log 114 associated with a network component (i.e., the electronic device 104) of an O-RAN (i.e., the system 102). Further, the electronic device 104 may generate the digest 116 associated with the event log 114. Further, the electronic device 104 may apply an encryption key on the digest 116 associated with the event log 114. Thereafter, the electronic device 104 may generate the encrypted digest 118 from the digest 116 based on the application of the encryption key on the digest 116. Further, the electronic device 104 may generate log information 120 associated with the network component (i.e., the electronic device 104) based on the event log 114 and the encrypted digest 118. The electronic device 104 may transmit the log information 120 to the service management component 106 of the O-RAN (i.e., the system 102). The electronic device 104 may control a display device to render the log information 120 based on a validation of the authenticity of the event log 114 by the service management component 106. Examples of the electronic device 104 (i.e., the network component) may include, but may not be limited to, an open-cloud (O-cloud) component, a radio unit (RU) component, a distributed unit (DU) component, a centralized unit (CU) component, or a near real-time radio intelligent controller (near-RT RIC) component.

The O-Cloud may correspond to a set of hardware and software components that may provide cloud computing capabilities for execution of radio access network functions. The software components may be coupled or decoupled from the hardware components as the software components and the hardware components may be sourced from same/different vendors. The O-Cloud may host one or more radio access network functionalities associated with the network components of the O-RAN. For example, the radio access network functionalities associated with each of the DU, CU-user plane (CU-UP), CU-control plane (CU-CP), near-RT RIC, and non-RT RIC components may be deployed over the O-Cloud as a software running on any commercially available off-the-shelf (COTS) hardware sourced from any vendor.

The RU may correspond to radio hardware that may covert radio signals, that may be received by or transmitted from antennas, into digital signals for transmission over packet-data networks. The RU may be configured to manage digital front end (DFE) and functionalities of the physical layer (i.e., layer-1 or L1). The RU may further manage digital beamforming functionality. The RU may be implemented on Field Programmable Gate Arrays (FPGAs) and Application-specific Integrated Circuits (ASICs). The RU may be deployed close to Radio Frequency (RF) antennas.

The DU may correspond to hardware, software, or a combination of hardware and software that may be configured to perform functionalities associated with medium access control (MAC) layer and radio link control (RLC) layer (i.e., real time layer-2 scheduling functions). The DU may further perform certain functionalities associated with physical layer (i.e., real time layer-1 scheduling functions). The DU may be hosted on on-site (i.e., along with the RU) on a COTS server or in an edge cloud (i.e., datacenter or central office) based on transport availability and fronthaul interface.

The CU may include two logical components, viz., the CU-CP and the CU-UP. The logical components, i.e., the CU-CP and the CU-UP, may be configured to perform different functionalities, associated with different hardware platforms, and deployed at different locations within the O-RAN (i.e., the system 102). For example, the CU-CP may manage control plane layers of the O-RAN, while the CU-UP may manage user plane layers of the O-RAN. The CU-CP and the CU-UP may perform non-real-time functionalities of radio resource control (RRC) layer, service data adaptation protocol (SDAP) layer and packet data convergence protocol (PDCP) layer. It may be noted that the CU may manage multiple DUs.

The near-RT RIC and non-RT RIC may be logical controllers that may run optimization routines with closed-loop control and orchestrate the O-RAN. The near-RT RIC and non-RT RIC may determine control policies and apply the determined control policies and actions on the network components of the O-RAN. The non-RT RIC may be included in the service management component 106 and influence operations of the service management component 106. The near-RT RIC may be deployed at the edge of the O-RAN (i.e., the system 102) and operate control loops with a certain periodicity. The near-RT RIC may interact with DUs and CUs in the O-RAN. The near-RT RIC may include multiple applications that support custom applications and services that may be required to support execution of the applications.

The service management component 106 may include suitable logic, circuitry, and interfaces, and/or code that may be configured to oversee orchestration aspects, management, and automation of the network components (such as the electronic device 104) of the O-RAN (i.e., the system 102). The service management component 106 may be further configured to support the O-RAN interfaces 112. In at least one embodiment, the service management component 106 may receive the log information 120 that may be transmitted by the electronic device 104 (i.e., a network component). The service management component 106 may validate the authenticity of the detected event log 114 based on a cryptographic key associated with the electronic device 104 (which may be received by the electronic device 104 from the key-delivery component 110) and the encrypted digest 118. The service management component 106 may further transmit a result indicative of authenticity of the detected event log 114 to the security management component 108. The result may correspond to information that specifies the detected event log 114 as real or fake. In some embodiments, the result may be sent to the electronic device 104 by the service management component 106. Similarly, the service management component 106 may validate authenticity of event logs, detected by other network components of the O-RAN, based on cryptographic keys associated with the other network components. Further, results indicative of authenticity of the event logs may be streamed to the security management component 108. Examples of the service management component 106 may be service management and orchestration (SMO). The SMO may include a non-RT RIC and support open interfaces of the O-RAN interfaces 112 connecting the SMO with the network components (such as the electronic device 104) of the O-RAN (i.e., the system 102).

The security management component 108 may include suitable logic, circuitry, interfaces, and/or code that may be configured to perform log management, event correlation, incident monitoring, response generation, and so on. The security management component 108 may obtain results indicative of authenticity of event logs (such as the detected event log 114) and log information (such as, the log information 120) from the security management component 108. The results and the log information may be processed to identify relationships and patterns in the log, detect deviations from expected behavior, perform real-time analysis, and determine appropriate actions to ensure security, prevent breach, block attacks, generate alerts, and counter threats. Examples of the security management component 108 may be a security information and event management (SIEM) that may be an amalgamation of security information management (SIM) and security event management (SEM) functions. The SIEM may facilitate real-time visibility and recognition of threats, centralization of log file data, troubleshooting, auditing, and compliance management.

The key-delivery component 110 may include suitable logic, circuitry, interfaces, and/or code that may be configured to store cryptographic keys associated with each of the network components (such as the electronic device 104) of the O-RAN. In at least one embodiment, each network component of the O-RAN may be associated with a unique cryptographic key. In some embodiments, all network components of the O-RAN may be associated with a single cryptographic key. The key-delivery component 110 may deliver the stored cryptographic keys to the electronic device 104 (and other network components), and the service management component 106. The key-delivery component 110 may function as a database that may be stored or cached on devices such as each of network components (including the electronic device 104) of the O-RAN and the service management component 106.

The O-RAN interfaces 112 may include a set of open interfaces via which network components (such as the electronic device 104) of the O-RAN (i.e., the system 102), the service management component 106, the security management component 108, and the key-delivery component 110, may communicate with each other. In at least one embodiment, the service management component 106, the security management component 108, and the key-delivery component 110 may be referred to as network components of the O-RAN. The set of open interfaces may include an E1 interface, an E2 interface, an A1 interface, an O1 interface, an O2 interface, and an open-fronthaul M-plane, and so on.

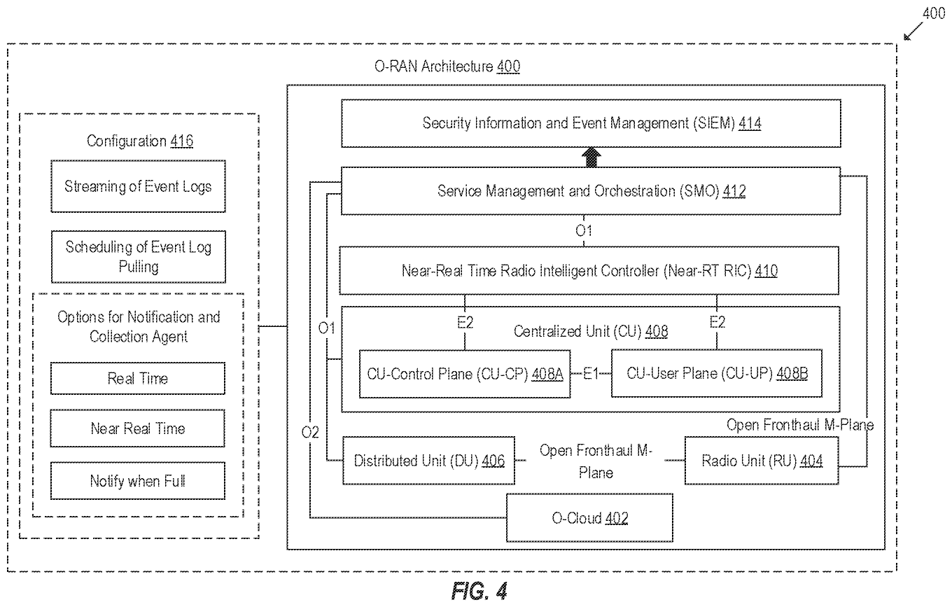

The E1 interface may connect the CU-CP and the CU-UP. The E2 interface may connect the near-RT RIC to the CU (i.e., the CU-CP and the CU-UP) and the DU. The E2 may enable streaming of telemetry, control instructions, and policies. The near-RT RIC may be connected to the non-RT RIC through the A1 interface. The non-RT RIC may be connected to other network components (i.e., RU, DU, CU, and near-RT RIC) of the O-RAN via the O1 interface. The O1 interface may enable management and orchestration of network functionalities. The non-RT RIC and the service management component 106 (SMO) may be connected to the O-Cloud through the O2 interface. The DU and RU may be connected to each other via the open-fronthaul M-plane. Details related to an exemplary architecture of the O-RAN are provided further, for example, in FIG. 4.

In operation, the electronic device 104 may be configured to detect the event log 114 (such as a first event log) associated with a network component (such as a first network component) of an O-RAN (i.e., the system 102). The O-RAN may include a set of network components. The electronic device 104 may be the first network component of the set of network components included in the O-RAN (system 102). The set of network components may include an O-cloud, a RU, a DU, a CU-CP, a CU-UP, or a near-RT RIC. The electronic device 104 (the first network component) may be one of the RU, the DU, the CU-CP, the CU-UP, or the near-RT RIC. The event log 114 (the first event log) may be detected based on an inclusion of the event log 114 on a depository of the electronic device 104. The detection of the event log 114 may be based on an occurrence of an event in the electronic device 104.

Similarly, other network components of the O-RAN (i.e., the system 102) may detect event logs that may be associated with the respective network components based on inclusions of the event logs in the depositories of the respective network components. The detection of the event logs may be based on occurrences of events in the respective network components of the O-RAN.

The electronic device 104 may be further configured to generate the digest 116 (such as a first digest) associated with the detected event log 114 (the first event log). The digest 116 (the first digest) associated with the event log 114 (the first event log) may be generated based on the detection of the event log 114 (the first event log). In accordance with an embodiment, the digest 116 (the first digest) may be a hash of the event log 114 (the first event log) that may be generated based on application of a digest generator on the event log 114. The digest generator may include a digest function that may generate the digest 116 as an output of the digest generator upon reception of the event log 114 as input. The output (i.e., the digest 116) may be of a predefined size that may correspond to a summary of the event log 114. The output may function as an identifier of the event log 114 (i.e., the first event log). For example, the digest 116 may be a digest value that may be returned by the digest generator.

Similarly, the other network components of the O-RAN may include digest generators which may be configured to generate digests associated with the event logs that may detected in the respective network components.

The electronic device 104 may be further configured to apply a first encryption key on the digest 116 (i.e., the first digest) associated with the event log 114 (i.e., the first event log). The first encryption key may be associated with the electronic device 104 or the first network component. In at least one embodiment, each network component of the set of network components may be associated with a unique encryption key. Thus, the key-delivery component 110 may generate a set of encryption keys that may include the first encryption key. The first encryption key may be an encryption key of the set of encryption keys that may be associated with the first network component that may be applied on the first digest.

Similarly, other encryption keys of the generated set of encryption keys maybe associated with the other network components of the set of network components. Those encryption keys may be applied on the generated digests associated with the event logs that have been detected by the other network components. For each detected event log, associated with each network component of the set of network components, a digest may be generated, and an encryption key associated with the corresponding network component may be applied on the digest.

In some embodiments, all network components of the O-RAN, i.e., the set of network components, may be associated with a single encryption key. The encryption key may be applied on all digests generated by the set of network components. The application of the encryption key may be regardless of association of the generated digests with different event logs, each of which may be, in-turn, associated with different network components of the set of network components.

The electronic device 104 may be further configured to generate an encrypted digest 118 (such as a first encrypted digest) from the digest 116 (such as the first digest) based on the application of the first encryption key on the digest 116 (i.e., the first digest). The encrypted digest 118 (the first encrypted digest) may be used for validation of authenticity of the event log 114 (first event log). The authenticity of the event log 114 (first event log) may be required to be validated for detection of fake event logs and deletion of any event log that may be determined as fake.

Similarly, encrypted digests may be generated based on applications of the encryption keys associated with the other network components of the O-RAN (i.e., the system 102). Such applications may be actualized based on an association of a unique encryption key with each network component of the set of network components. The unique encryption key associated with a corresponding network component may be applied on a digest that may be generated by the corresponding network component.

On the other hand, in another scenario, the encrypted digests may be generated based on an application of the same encryption key (such as the first encryption key) on all digests that may be generated by the set of network components of the O-RAN (the system 102). Thus, a set of encrypted digests may be generated for validation of authenticity of the event logs (including the first event log) associated with the set of network components.

The electronic device 104 may be further configured to generate log information 120 (such as, first log information) associated with the network component (such as, the first network component). The generation of the log information 120 (the first log information) may be based on the event log 114 (the first event log) and the encrypted digest 118 (the first encrypted digest). In accordance with an embodiment, the encrypted digest 118 (the first encrypted digest) may be concatenated with the event log 114 (the first event log) for generation of the log information 120 (the first log information). Similarly, log information associated with each network component of the set of network components may be generated.

The electronic device 104 may be further configured to transmit the log information 120 (for example, the first log information) to the service management component 106 (such as, the SMO) of the O-RAN (i.e., the system 102). The log information 120 (i.e., the first log information) may be transmitted for validation of authenticity of the event log 114 (the first event log) by the service management component 106. The service management component 106 may be configured to validate the authenticity of the detected event log 114 (for example, the first event log) based on the encrypted digest 118 (the first encrypted digest). The event log 114 (the first event log) may be determined as authentic or inauthentic (fake) based on an outcome of validation that may be generated by the service management component 106 (e.g., the SMO).

In accordance with an embodiment, the service management component 106 may be configured to extract, from the log information 120 (i.e., the first log information), the event log 114 (the first event log) and the encrypted digest 118 (the first encrypted digest). Once the encrypted digest 118 is extracted, the encrypted digest 118 may be decrypted. For the decryption, the service management component 106 may obtain, from the key-delivery component 110, the first encryption key that may be associated with the electronic device 104 or the first network component. After obtaining the first encryption key, the service management component 106 may decrypt the encrypted digest 118 based on the first encryption key and determine an authentication result. The authentication result may indicate an authenticity of the event log 114 (the first event log) based on the decryption. The event log 114 (the first event log) may be validated as authentic or indicated as fake. The service management component 106 may be further configured to transmit the authentication result to the electronic device 104 (i.e., the first network component) and the security management component 108.

Similarly, log information that associated with each of the other network components of the set of network components may be transmitted to the service management component 106 for validation of authenticity of event logs associated with each of the other network components. The service management component 106 may validate the authenticity of each event log associated with each of the other network components of the set of network components. The validation may be based on an extraction of an encrypted digest from log information associated with each of the other network components and decryption of the encrypted digest using the encryption key associated with each of the other network components. The encryption key used for the decryption may be unique for each network component may. In some embodiments, the same encryption key associated with all network components (i.e., the set of network components) may be used for the decryption.

The electronic device 104 may be further configured to control a display device (such as a first display device associated with the electronic device 104 or the first network component) to render the log information 120 (the first log information) based on the validation of the authenticity of the event log 114 (the first event log). Similarly, the other network components of the set of network components may control display devices that are associated with corresponding network components. The display devices may be controlled for rendering of the log information associated with the other network components based on validation of authenticity of the event logs associated with the respective network components of the O-RAN.

Modifications, additions, or omissions may be made to FIG. 1 without departing from the scope of the disclosure. For example, the network environment 100 may include more or fewer elements than those illustrated and described in the present disclosure. In some embodiments, the functionality of each of the service management component 106 and the security management component 108 may be incorporated into one of the network components of the system 102, such as, the electronic device 104, without a deviation from the scope of the disclosure.

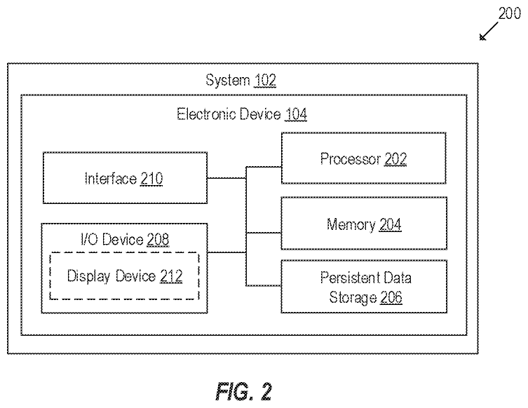

FIG. 2 is a block diagram that illustrates an exemplary electronic device for facilitating tamper-proof event logging in O-RANs, in accordance with at least one embodiment described in the present disclosure. FIG. 2 is explained in conjunction with elements from FIG. 1. With reference to FIG. 2, there is shown a block diagram 200 of the system 102, i.e., a portion of the O-RAN, that includes the electronic device 104 (i.e., the first network component). The electronic device 104 may include a processor 202, a memory 204, a persistent data storage 206, an input/output (I/O) device 208, and an interface 210. In at least one embodiment, the I/O device 208 may include a display device 212. It may be noted that each of the other network components of the O-RAN may include a processor, a memory, a persistent data storage, and an I/O device that includes a display device.

The processor 202 may include suitable logic, circuitry, and interfaces that may be configured to execute a set of instructions stored in the memory 204. The processor 202 may be configured to execute program instructions associated with different operations to be executed by the electronic device 104. The processor 202 may be configured to detect the first event log (such as the event log 114) associated with a first network component (i.e., the electronic device 104) of the O-RAN (i.e., the system 102). The processor 202 may be further configured to generate a first digest (such as the digest 116) associated with the first event log. The processor 202 may be further configured to apply a first encryption key on the first digest associated with the first event log. The processor 202 may be further configured to generate a first encrypted digest (such as the encrypted digest 118) from the first digest based on the application of the first encryption key on the first digest. The processor 202 may be further configured to generate first log information (such as the log information) that may be associated with the first network component (i.e., the electronic device 104) based on the first event log and the first encrypted digest. The processor 202 may be further configured to transmit the first log information to the service management component 106 (such as the SMO) of the O-RAN (i.e., the system 102) for validation of authenticity of the detected first event log by the service management component 106 using the generated first encrypted digest. The processor 202 may be further configured to control a first display device (i.e., the display device 212) to render the first log information based on the authenticity of the first event log. The processor 202 may be implemented based on a number of processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), a co-processor, or a combination thereof.

Although illustrated as a single processor in FIG. 2, the processor 202 may include any number of processors configured to, individually or collectively, perform or direct performance of any number of operations of the electronic device 104, as described in the present disclosure. Additionally, one or more of the processors may be present on one or more different electronic devices, such as different servers. In at least one embodiment, the processor 202 may be configured to interpret and/or execute program instructions, or process data that may be stored in the memory 204 or the persistent data storage 206. In some embodiments, the processor 202 be configured to may fetch program instructions from the persistent data storage 206 and load the program instructions in the memory 204. After the program instructions are loaded into the memory 204, the processor 202 may execute the program instructions.

The memory 204 may include suitable logic, circuitry, and interfaces that may be configured to store the one or more instructions to be executed by the processor 202. The one or more instructions stored in the memory 204 may be executed by the processor 202 to perform the different operations of the processor 202 (and the electronic device 104). The memory 204 may store the first event log associated with the first network component (i.e., the electronic device 104) of the O-RAN (i.e., the system 102), the first digest associated with the detected first event log, the first encryption key, the first encrypted digest, and the first log information associated with the first network component. Examples of implementation of the memory 204 may include, but are not limited to, a CPU cache, a Hard Disk Drive (HDD), a Solid-State Drive (SSD), Random Access Memory (RAM), Read Only Memory (ROM), Electrically Erasable Programmable Read-Only Memory (EEPROM), and/or a Secure Digital (SD) card.

The persistent data storage 206 may include suitable logic, circuitry, and/or interfaces that may be configured to store program instructions executable by the processor 202. The persistent data storage 206 may include computer-readable storage media for carrying or having computer-executable instructions or data structures stored thereon. Such computer-readable storage media may include any available media that may be accessed by a general-purpose or special-purpose computer, such as the processor 202. By way of example, and not limitation, such computer-readable storage media may include tangible or non-transitory computer-readable storage media, or any other storage medium which may be used to carry or store particular program code in the form of computer-executable instructions or data structures, which may be accessed by a general-purpose or special-purpose computer. Computer-executable instructions may include, for example, instructions and data configured to cause the processor 202 to perform a certain operation or group of operations associated with the electronic device 104 or the first network component of the O-RAN (i.e., the system 102).

The I/O device 208 may include suitable logic, circuitry, and interfaces that may be configured to receive inputs and render outputs based on the received inputs. For example, the I/O device 208 may receive an input that may trigger detection of the first event log associated with the first network component (i.e., the electronic device 104). The I/O device 208 may further receive a user input indicative of instructions to control a first display device (such as the display device 212) to render the first log information. Further, the I/O device 208 may render outputs such as the first log information based on validation of the authenticity of the first event log. The I/O device 208 may include various input and output devices, which may be configured to communicate with the processor 202. Examples of the I/O device 208 may include, but are not limited to, a touch screen, a keyboard, a mouse, a joystick, the display device 212, a microphone, and a speaker.

The interface 210 may include suitable logic, circuitry, and interfaces that may be configured to facilitate communication between the processor 202 (i.e., the electronic device 104 or the first network component of the O-RAN) and each of other network components of the O-RAN, the service management component 106 (i.e., the SMO), the security management component 108 (i.e., the SIEM), and the key-delivery component 110, via the O-RAN interfaces 112 (for example, the E1 interface, the E2 interface, the A1 interface, the O1 interface, the O2 interface, and the open-fronthaul M-plane). The interface 210 may be implemented by use of various known technologies to support wired or wireless communication of the electronic device 104 with the O-RAN interfaces 112.

The display device 212 may include suitable logic, circuitry, and interfaces that may be configured to render the first log information associated with the first network component (i.e., the electronic device 104). The display device 212 may be a touch screen which may enable a user to provide user-inputs via the display device 212. The touch screen may be at least one of a resistive touch screen, a capacitive touch screen, or a thermal touch screen. The display device 212 may be realized through several known technologies such as, but not limited to, a Liquid Crystal Display (LCD) display, a Light Emitting Diode (LED) display, a plasma display, or an Organic LED (OLED) display technology, or other display devices. In accordance with an embodiment, the display device 212 may refer to a display screen of a head mounted device (HMD), a smart-glass device, a see-through display, a projection-based display, an electro-chromic display, or a transparent display.

Modifications, additions, or omissions may be made to the example electronic device 104 without departing from the scope of the present disclosure. For example, in some embodiments, the example electronic device 104 may include any number of other components that may not be explicitly illustrated or described for the sake of brevity.

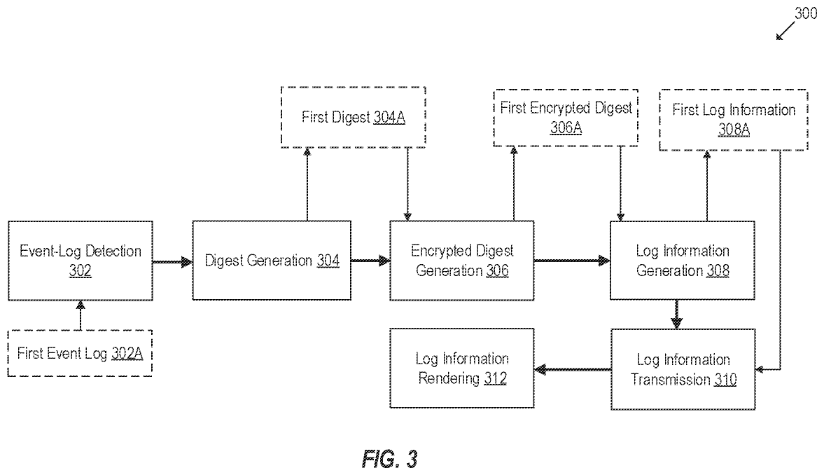

FIG. 3 is a diagram that illustrates an exemplary execution pipeline for facilitating tamper-proof event logging in O-RANs, in accordance with an embodiment of the disclosure. FIG. 3 is described in conjunction with elements from FIG. 1, and FIG. 2. With reference to FIG. 3, there is shown an execution pipeline 300. The exemplary execution pipeline 300 may include a sequence of operations that may be executed by the processor 202 of the electronic device 104 of FIG. 1 for providing a tamper-proof logging system for an O-RAN. In the execution pipeline 300, there is shown a sequence of operations that may start from 302 and end at 312.

At 302, a first event log 302A may be detected. In at least one embodiment, the processor 202 may be configured to detect the first event log 302A. The first event log 302A may be associated with a first network component (i.e., the electronic device 104) of an O-RAN. The detection of the first event log 302A may be based on inclusion or registration of the first event log 302A on a depository of the first network component. The first event log 302A may be included in the depository for recording an occurrence of one or more events that may be of importance and needs to be recognized. The first event log 302A may include information associated with each of the one or more events that may be arranged in a particular order. The information associated with an event may include a timestamp of occurrence of each of the event, a description of the event, severity of the event, applications associated with the event, or any other particulars associated with the event. The registration or inclusion of the first event log 302A on the depository of the first network component may be based on the occurrence of the one or more events in the first network component. Once the first event log 302A is included in the memory 204, the first event log 302A may be detected.

In accordance with an embodiment, the O-RAN may include a set of network components. The set of network components may include the first network component. The set of network components further include a second network component that may be different from the first network component. Each network component of the set of network components may be different from remaining network components of the set of network components. The set of network components may include at least one of: an open-cloud (O-cloud) component, a radio unit (RU) component, a distributed unit (DU) component, a centralized unit (CU) component, or a radio intelligent controller (RIC) component. The CU component may include a CU-user plane (CU-UP) component and a CU-control plane (CU-CP) component. The RIC component may include a near-real time RIC (near-RT RIC) component and a non-real time RIC (non-RT RIC) component. The non-RT RIC component may be included in the service management component 106.

Similar to the detection of the first event log 302A by the processor 202, the second network component may include a processor. The processor of the second network component may be configured to detect a second event log. The second event log may be associated with the second network component of the set of network components. The detection of the second event log may be based on inclusion of the second event log in the depository of the second network component. The second event log may be included in the depository of the second network component for recording an occurrence of events in the second network component.

At 304, a first digest 304A, associated with the detected first event log 302A, may be generated. In at least one embodiment, the processor 202 may be configured to generate the first digest 304A associated with the detected first event log 302A. The generation of the first digest 304A may be triggered based on the detection of the first event log 302A. The processor 202 may apply a digest generator on the first event log 302A. The digest generator may be included in the first network component (i.e., the electronic device 104). The digest generator may apply a hash function or a digest function on the first event log 302A for generation of a hash of the first event log 302A as output of the digest generator. The hash of the first event log 302A, i.e., the output, may correspond to the first digest 304A. The digest function may be a mathematical function that may apply a series of mathematical operations on the first event log 302A such that the hash of the first event log 302A, i.e., the first digest 304A, is generated. The first digest 304A may be a digital summary of the first event log 302A that may act as a digital identifier of the first event log 302A.

In accordance with an embodiment, the processor of the second network component may generate a second digest associated with the second event log. The generation of the second digest may be based on application of a digest generator of the second network component on the second event log.

At 306, a first encrypted digest 306A may be generated from the first digest 304A. In at least one embodiment, the processor 202 may be configured to generate the first encrypted digest 306A from the first digest 304A. The generation of the first encrypted digest 306A may be based on an application of a first encryption key on the first digest 304A associated with the first event log 302A. The first encryption key may be received by the first network component (i.e., the electronic device 104) from the key-delivery component 110 of the O-RAN. The key-delivery component 110 may generate the first encryption key and, thereafter, transmit the first encryption key to the first network component. Once the first encryption key is received, the processor 202 may apply the first encryption key on the first digest 304A for encrypting the first digest 304A. The encryption of the first digest 304A may result in the generation of the first encrypted digest 306A.

In accordance with an embodiment, the first encryption key may correspond to a secret encryption key. The key-delivery component 110 may transmit or distribute the secret encryption key (i.e., the first encryption key) to the set of network components (i.e., all network components of the O-RAN). Thus, both the first network component and the second network component (and each of the other network components of the O-RAN) may receive the same first encryption key. The processor of the second network component, upon reception of the first encryption key from the key-delivery component 110, may apply the first encryption key on the second digest associated with the second event log. Based on the application of the first encryption key on the second digest, a second encrypted digest may be generated from the second digest.

In accordance with an embodiment, the key-delivery component 110 may generate a set of encryption keys. Each encryption key of the set of encryption keys may be different from remaining encryption keys of the generated set of encryption keys. In an embodiment, each encryption key of the set of encryption keys may correspond to a secret encryption key. Further, each encryption key of the set of encryption keys may be generated for delivery to a particular network component. For example, a first encryption key of the set of encryption keys may be generated for delivery to the first network component and a second encryption key of the set of encryption keys may be generated for delivery to the second network component. Each network component of the set of network components of the O-RAN may be configured to receive an encryption key of a set of encryption keys from the key-delivery component 110. The first network component may receive the first encryption key that may be included in the set of encryption keys. Similarly, the second network component may receive the second encryption key that may be included in the set of encryption keys. The second encryption key may be different from the first encryption key and may correspond to an encryption key associated with the second network component.

In such a scenario, the processor 202 may apply the first encryption key on the first digest 304A associated with the first event log 302A to generate the first encrypted digest 306A. Similarly, the processor of the second network component may apply second encryption key of the set of encryption keys on the second digest associated with the second event log to generate a second encrypted digest from the second digest.

At 308, first log information 308A, which may be associated with the first network component, may be generated based on the detection of the first event log 302A and the generation of the first encrypted digest 306A. In at least one embodiment, the processor 202 may be configured to generate the first log information 308A, which may be associated with the first network component. The generation of the first log information 308A may be based on the first event log 302A and the first encrypted digest 306A. The processor 202 may apply a concatenation operation on the first event log 302A and the first encrypted digest 306A. The generation of the first log information 308A may be based on the application of the concatenation operation.

In accordance with an embodiment, the processor of the second network component may generate second log information, which may be associated with the second network component. The generation of the second log information may be based on the second event log and the second encrypted digest. The processor of the second network component may apply a concatenation operation on the second event log and the second encrypted digest to generate the second log information. The first log information 308A and the second log information may be used to validate authenticity of the first event log and the second event log respectively. The authenticity of event logs, which may be associated with the remaining network components (apart from the first and second network components) of the set of network components, may be validated based on log information associated with the remaining network components.

At 310, the first log information 308A may be transmitted to the service management component 106 of the O-RAN. In at least one embodiment, the processor 202 may be configured to transmit the first log information 308A to the service management component 106 (i.e., the service management and orchestration (SMO)) of the O-RAN. The first log information 308A may be transmitted to the service management component 106 for validating an authenticity of the first event log 302A. The service management component 106 may be configured to receive the first log information 308A from the first network component. The service management component 106 may validate, based on the generated first encrypted digest 306A, the authenticity of the first event log 302A. For obtaining the first encrypted digest 306A, the service management component 106 may extract, from the received first log information 308A, the first event log 302A and the first encrypted digest 306A.

Similarly, the processor of the second network component may transmit the second log information to the service management component 106 for validating an authenticity of the second event log. The service management component 106 may receive the second log information from the second network component. The service management component 106 may validate the authenticity of the second event log based on the second encrypted digest. The second encrypted digest may be obtained based on extraction, from the received second log information, of the second event log and the second encrypted digest.

In accordance with an embodiment, the service management component 106 may be configured to receive the first encryption key from the key-delivery component 110. Based on the first encryption key, the service management component 106 may decrypt each of the first encrypted digest 306A and the second encrypted digest. Based on the decryption of the first encrypted digest 306A, a result of validation of the first event log 302A may be obtained. The result may indicate whether the first event log 302A is authentic or inauthentic (i.e., fake). Similarly, based on the decryption of the second encrypted digest, a result of validation of the second event log may be obtained. The result may indicate whether the second event log is authentic or inauthentic (i.e., fake). The results of validation of the first event log 302A and the second event log may be obtained sequentially or in parallel based on processing/computational capabilities of the service management component 106 of the O-RAN.

In accordance with an embodiment, the service management component 106 may be configured to receive each encryption key of the set of encryption keys from the key-delivery component 110. Based on the first encryption key of the received set of encryption keys, the service management component 106 may decrypt the first encrypted digest 306A. Based on the decryption of the first encrypted digest 306A, the service management component 106 may determine whether the first event log 302A is associated with the first network component (i.e., the electronic device 104). The service management component 106 may further determine a result of validation of the first event log 302A. Similarly, based on the second encryption key of the received set of encryption keys, the service management component 106 may decrypt the second encrypted digest. Based on the decryption of the second encrypted digest, the service management component 106 may determine whether the second event log is associated with the second network component. The service management component 106 may further determine, a result of validation of the second event log. The results of validation of the first event log 302A and the second event log may be obtained sequentially or in parallel based on processing/computational capabilities of the service management component 106 of the O-RAN.

In accordance with an embodiment, the service management component 106 may transmit the result of the validation of the authenticity of the first event log 302A and the first log information 308A to the security management component 108 (i.e., the security information and event management (SIEM)) of the O-RAN and the first network component. The service management component 106 may further transmit the result of the validation of the authenticity of the second event log and the second log information to the security management component 108 and the second network component. The security management component 108 may determine actions that may be required to be executed to ensure security of the O-RAN and such that the O-RAN may continue to offer uninterrupted services. The determination of the actions may be based on the result of the validation of the authenticity of the first event log 302A, the second event log, and/or other event logs that may be detected by the remaining network components of the set of network components of the O-RAN.

At 312, a first display device (i.e., the display device 212) may be controlled to render the first log information 308A based on the validation of the authenticity of the first event log 302A. In at least one embodiment, the processor 202 may be configured to control the first display device to render the first log information 308A based on the authenticity of the first event log 302A. Similarly, the processor of the second network component may control a second display device to render the second log information based on the validation of the authenticity of the second event log.

Embodiments of the disclosure may facilitate tamper-proof logging of events that may be occurring in the network components (such as, the electronic device 104) of an O-RAN. The embodiments may ensure integrity and authenticity of event logs that may be detected by the network components. As such, attacks (such as denial-of-service attacks) on the O-RAN due to entry of inauthentic (i.e., fake) event logs in depositories of the network components of the O-RAN may be avoided. To ensure tamper-proof logging of events, the embodiments disclose monitoring, identifying, and validating authenticity of, each event log associated with each network component of the O-RAN that may be included in the depository of the corresponding network component. The authenticity of each event log may be validated by use of one or more encryption keys that may be used for encryption of event log digests and decryption of encrypted event log digests. In scenarios where multiple encryption keys are involved, and each network component of the O-RAN is associated with a unique encryption key, the embodiments enable identification of a network component of the O-RAN with which an event log may be associated. This may allow the security management component 108 of the O-RAN to monitor parameters such as a count of fake event logs across sessions, determine network components that are more vulnerable compared to other network components of the O-RAN, and determine actions to be executed for mitigation of the vulnerabilities. The count of fake event logs associated with vulnerable network components may be higher compared to count of fake event logs associated with other network components.

FIG. 4 is a diagram that illustrates an exemplary architecture of an O-RAN, in accordance with an embodiment of the disclosure. FIG. 4 is described in conjunction with elements from FIG. 1, FIG. 2, and FIG. 3. With reference to FIG. 4, there is shown a block diagram of an exemplary O-RAN architecture 400. The O-RAN architecture 400 may include an O-Cloud 402, an RU 404, a DU 406, a CU 408, a near-RT RIC 410, an SMO 412, and an SIEM 414. In at least one embodiment the CU 408 may include a CU-CP 408A and a CU-UP 408B. The O-RAN architecture 400 may include configurations 416 that may be used for streaming of event logs and options that may be used for collection and issuing notifications. Each of the O-Cloud 402, the RU 404, the DU 406, the CU 408 (i.e., the CU-CP 408A and the CU-UP 408B), the near-RT RIC 410, the SMO 412, and the SIEM 414, may be disaggregated radio access network components. Details of functionality of each of the O-Cloud 402, the RU 404, the DU 406, the CU 408 (i.e., the CU-CP 408A and the CU-UP 408B), the near-RT RIC 410, the SMO 412, and the SIEM 414, are included, for example, in FIG. 1.

In accordance with an embodiment, the electronic device 104 may be one of devices or set of devices associated with the O-Cloud 402, the RU 404, the DU 406, the CU-CP 408A, the CU-UP 408B, or the near-RT RIC 410. The SMO 412 may correspond to the service management component 106. Further, the SIEM 414 may correspond to the security management component 108. The CU-CP 408A and the CU-UP 408B may be connected to each other via the E1 interface. The near-RT RIC 410 may be connected to each of the CU-CP 408A and the CU-UP 408B via the E2 interface. The SMO 412 (specifically the non-RT RIC (not shown) included in the SMO 412) may be connected to each of the DU 406, the CU-CP 408A, the CU-UP 408B, or the near-RT RIC 410, via the O1 interface. The SMO 412 may be connected to the O-Cloud 402, via the O2 interface. The SMO 412 may be connected to each of the RU 404 via the open-fronthaul M-plane. Further, the RU 404 and the DU 406 may be connected to each other via the open-fronthaul M-plane.

The configurations 416 may include protocols associated with pulling of event logs by the SMO 412 from depositories of each of the o-cloud 402, the RU 404, the DU 406, the CU-CP 408A, the CU-UP 408B, or the near-RT RIC 410. The pulling of the event logs may be scheduled based on the protocols. Once the event logs are pulled, the SMO 412 may validate authenticity of each of the event logs. The SMO 412 may stream results of validation of the authenticity of the event logs. The streaming of the results may be continuous based on the protocols. Further, the configurations 416 may include options, based on which notification and collection agents may execute actions such as collect and issue notifications in real-time, near real-time, or when a memory configured to store the collected notifications is full. The notification and collection agents may be included in each of RU 404, the DU 406, the CU-CP 408A, the CU-UP 408B, the near-RT RIC 410, or the SMO 412.

It should be noted that the O-RAN architecture 400 is for exemplary purposes and should not be construed to limit the scope of the disclosure.

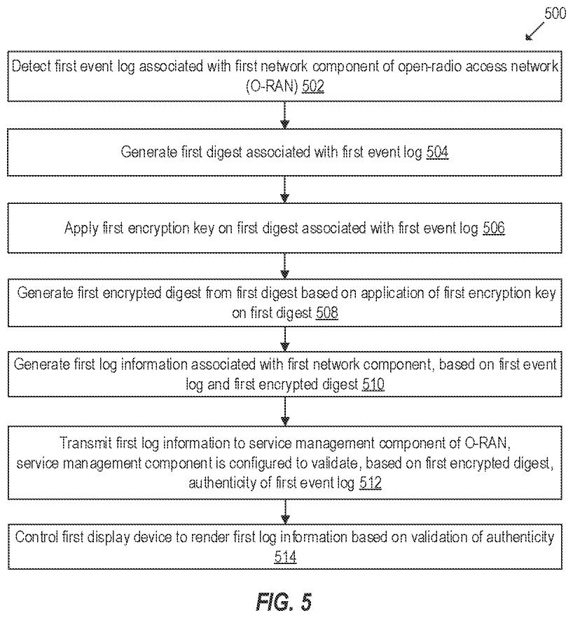

FIG. 5 is a diagram that illustrates a flowchart of an example method for facilitating tamper-proof event logging in O-RANs, in accordance with an embodiment of the disclosure. FIG. 5 is described in conjunction with elements from FIG. 1, FIG. 2, FIG. 3, and FIG. 4. With reference to FIG. 5, there is shown a flowchart 500. The method illustrated in the flowchart 500 may start at 502 and may be performed by any suitable system, apparatus, or device, such as, by the example electronic device 104 of FIG. 1, or the processor 202 of FIG. 2. Although illustrated with discrete blocks, the steps and operations associated with at least one block of the flowchart 500 may be divided into additional blocks, combined into fewer blocks, or eliminated, depending on the particular implementation.

At block 502, a first event log (such as event log 114), associated with a first network component (such as the electronic device 104) of an O-RAN (such as the system 102), may be detected. In an embodiment, the processor 202 may be configured to detect the first event log (i.e., the event log 114) that may be associated with the first network component (i.e., the electronic device 104) of the O-RAN (i.e., the system 102). Details of detection of the first event log (i.e., the event log 114) associated with the first network component (i.e., the electronic device 104) are further provided, for example, in FIG. 1 and FIG. 3.

At block 504, a first digest (such as the digest 116), associated with the first event log (i.e., the event log 114), may be generated. In an embodiment, the processor 202 may be configured to generate the first digest (i.e., the digest 116) associated with the first event log (i.e., the event log 114). Details of generation of the first digest (i.e., the digest 116) associated with the first event log (i.e., the event log 114) are further provided, for example, in FIG. 1 and FIG. 3.

At block 506, a first encryption key may be applied on the first digest (i.e., the digest 116) associated with the first event log (i.e., the event log 114). In an embodiment, the processor 202 may be configured to apply the first encryption key on the first digest (i.e., the digest 116) associated with the first event log (i.e., the event log 114). Details of application of the first encryption key on the first digest (i.e., the digest 116) are further provided, for example, in FIG. 1 and FIG. 3.

At block 508, a first encrypted digest (such as the encrypted digest 118) may be generated from the first digest (i.e., the digest 116) on the application of the first encryption key on the first digest (i.e., the digest 116). In an embodiment, the processor 202 may be configured to generate the first encrypted digest (i.e., the encrypted digest 118) from the first digest (i.e., the digest 116) based on the application of the first encryption key on the first digest (i.e., the digest 116). Details of generation of the first encrypted digest (i.e., the encrypted digest 118) from the first digest (i.e., the digest 116) are further provided, for example, in FIG. 1 and FIG. 3.

At block 510, first log information (such as the log information 120), associated with the first network component (i.e., the electronic device 104), may be generated based on the first event log (i.e., the event log 114) and the first encrypted digest (i.e., the encrypted digest 118). In an embodiment, the processor 202 may be configured to generate the first log information (i.e., the log information 120) associated with the first network component (i.e., the electronic device 104), based on the first event log (i.e., the event log 114) and the first encrypted digest (i.e., the encrypted digest 118). Details of generation of the first log information (i.e., the log information 120) associated with the first network component (i.e., the electronic device 104) are further provided, for example, in FIG. 1 and FIG. 3.

At block 512, the first log information (i.e., the log information 120) may be transmitted to a service management component (such as the service management component 106) of the O-RAN. In an embodiment, the processor 202 may be configured to transmit the first log information to the service management component of the O-RAN (i.e., the system 102). The service management component 106 may be configured to validate, based on the first encrypted digest (i.e., the encrypted digest 118), an authenticity of the first event log (i.e., the event log 114). Details of transmission of the first log information (i.e., the log information 120) to the service management component 106 and subsequent validation of the authenticity of the first event log (i.e., the event log 114) by the service management component 106 are further provided, for example, in FIG. 1 and FIG. 3.

At block 514, a first display device (such as the display device 212) may be controlled to render the first log information (i.e., the log information 120) based on the authenticity of the first event log (i.e., the event log 114). In an embodiment, the processor 202 may be configured to control the first display device (i.e., the display device 212) to render the first log information (i.e., the log information 120) based on the authenticity of the first event log (i.e., the event log 114). Details of controlling of the first display device (e.g., the display device 212) for rendering of the first log information (i.e., the log information 120) are further provided, for example, in FIG. 1 and FIG. 3.

Although the flowchart 500 is illustrated as discrete operations, such as 502 504, 506, 508, 510, 512, and 514, the disclosure is not so limited. However, in certain embodiments, such discrete operations may be further divided into additional operations, combined into fewer operations, or eliminated, depending on the particular implementation without detracting from the essence of the disclosed embodiments.

Various embodiments of the disclosure may provide one or more non-transitory computer-readable storage media configured to store instructions that, in response to being executed, cause a first networking component (such as the electronic device 104) of an O-RAN (such as the system 102) to perform operations. The operations may include detecting a first event log (such as the event log 114) associated with a first network component (i.e., the electronic device 104) of the O-RAN (i.e., the system 102). The operations may further include generating a first digest (such as the digest 116) associated with the first event log (i.e., the event log 114). The operations may further include applying a first encryption key on the first digest (i.e., the digest 116) associated with the first event log (i.e., the event log 114). The operations may further include generating a first encrypted digest (such as the encrypted digest 118) from the first digest (i.e., the digest 116) based on the application of the first encryption key on the first digest (i.e., the digest 116). The operations may further include generating first log information (such as the log information 120) associated with the first network component (i.e., the electronic device 104), based on the first event log (i.e., the event log 114) and the first encrypted digest (i.e., the encrypted digest 118). The operations may further include transmitting the first log information (i.e., the log information 120) to a service management component (such as the service management component 106) of the O-RAN (i.e., the system 102). The service management component 106 may be configured to validate, based on the first encrypted digest (i.e., the encrypted digest 118), an authenticity of the first event log (i.e., the event log 114). The operations may further include controlling a first display device (such as the display device 212) to render the first log information (i.e., the log information 120) based on the authenticity of the first event log (i.e., the event log 114).

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, executed by a processor, comprising:
detecting a first event log associated with a first network component of an open-radio access network (O-RAN);
generating a first digest associated with the first event log;
applying a first encryption key on the first digest associated with the first event log;
generating a first encrypted digest from the first digest based on the application of the first encryption key on the first digest;
generating first log information associated with the first network component, based on the first event log and the first encrypted digest;
transmitting the first log information to a service management component of the O-RAN,
the service management component is configured to validate, based on the first encrypted digest, an authenticity of the first event log; and
controlling a first display device to render the first log information based on the authenticity of the first event log.

2. The method according to claim 1, wherein the service management component is further configured to transmit a result of the validation of the authenticity of the first event log and the first log information to a security management component of the O-RAN and the first network component.

3. The method according to claim 1, further comprising receiving the first encryption key by the first network component from a key-delivery component of the O-RAN.

4. The method according to claim 3, wherein
the first encryption key corresponds to a secret encryption key distributed to a set of network components of the O-RAN by the key-delivery component, and
the set of network components includes the first network component.

5. The method according to claim 3, wherein
each network component of a set of network components of the O-RAN is configured to receive a corresponding encryption key of a set of encryption keys from the key-delivery component,
each encryption key of the set of encryption keys corresponds to a secret encryption key,
the set of network components includes the first network component, and
the set of encryption keys includes the first encryption key.

6. The method according to claim 5, wherein
each network component of the set of network components is different from remaining network components of the set of network components, and
each encryption key of the set of encryption keys is different from remaining encryption keys of the set of encryption keys.

7. The method according to claim 5, wherein the service management component is further configured to receive each encryption key of the set of encryption keys from the key-delivery component.

8. The method according to claim 7, wherein a second network component, different from the first network component, of the set of network components is configured to:
detect a second event log associated with the second network component of the set of network components;
generate a second digest associated with the second event log;
apply a second encryption key of the set of encryption keys on the second digest associated with the second event log,
the second encryption key is different from the first encryption key, and
the second encryption key corresponds to an encryption key associated with the second network component;
generate a second encrypted digest from the second digest based on the application of the second encryption key on the second digest;
generate second log information associated with the second network component, based on the second event log and the second encrypted digest;
transmit the second log information to the service management component,
the service management component is further configured to validate, based on the second encrypted digest, an authenticity of the second event log; and
control a second display device to render the second log information based on the authenticity of the second event log.

9. The method according to claim 8, wherein the service management component is further configured to transmit a result of the validation of the authenticity of the second event log and the second log information to a security management component of the O-RAN and the second network component.

10. The method according to claim 1, wherein the set of network components includes at least one of: an open-cloud (O-cloud) component, a radio unit (RU) component, a distributed unit (DU) component, a centralized unit (CU) component, or a radio intelligent controller (RIC) component.

11. The method according to claim 1, further comprising:
applying a concatenation operation on the first event log and the first encrypted digest, wherein
the generation of the first log information is further based on the concatenation operation.

12. One or more non-transitory computer-readable storage media configured to store instructions that, in response to being executed, cause an electronic device to perform operations, the operations comprising:
detecting a first event log associated with a first network component of an open-radio access network (O-RAN);
generating a first digest associated with the first event log;
applying a first encryption key on the first digest associated with the first event log;
generating a first encrypted digest from the first digest based on the application of the first encryption key on the first digest;
generating first log information associated with the first network component, based on the first event log and the first encrypted digest;
transmitting the first log information to a service management component of the O-RAN,
the service management component is configured to validate, based on the first encrypted digest, an authenticity of the first event log; and
controlling a first display device to render the first log information based on the authenticity of the first event log.

13. The one or more non-transitory computer-readable storage media according to claim 12, wherein the service management component is further configured to transmit a result of the validation of the authenticity of the first event log and the first log information to a security management component of the O-RAN and the first network component.

14. The one or more non-transitory computer-readable storage media according to claim 12, wherein the operations further comprise receiving the first encryption key by the first network component from a key-delivery component of the O-RAN.

15. The one or more non-transitory computer-readable storage media according to claim 14, wherein
the first encryption key corresponds to a secret encryption key distributed to a set of network components of the O-RAN by the key-delivery component, and
the set of network components includes the first network component.

16. The one or more non-transitory computer-readable storage media according to claim 14, wherein
each network component of a set of network components of the O-RAN is configured to receive a corresponding encryption key of a set of encryption keys from the key-delivery component,
each encryption key of the set of encryption keys corresponds to a secret encryption key,
the set of network components includes the first network component, and
the set of encryption keys includes the first encryption key.

17. The one or more non-transitory computer-readable storage media according to claim 16, wherein the service management component is further configured to receive each encryption key of the set of encryption keys from the key-delivery component.

18. The one or more non-transitory computer-readable storage media according to claim 17, wherein a second network component, different from the first network component, of the set of network components is configured to:
detect a second event log associated with the second network component of the set of network components;
generate a second digest associated with the second event log;
apply a second encryption key of the set of encryption keys on the second digest associated with the second event log,
the second encryption key is different from the first encryption key, and
the second encryption key corresponds to an encryption key associated with the second network component;
generate a second encrypted digest from the second digest based on the application of the second encryption key on the second digest;
generate second log information associated with the second network component, based on the second event log and the second encrypted digest;
transmit the second log information to the service management component,
the service management component is further configured to validate, based on the second encrypted digest, an authenticity of the second event log; and
control a second display device to render the second log information based on the authenticity of the second event log.

19. The one or more non-transitory computer-readable storage media according to claim 18, wherein the service management component is further configured to transmit a result of the validation of the authenticity of the second event log and the second log information to a security management component of the O-RAN and the second network component.

20. An electronic device, comprising:
a memory configured to store instructions; and
a processor, coupled to the memory, configured to execute the instructions to perform a process comprising:
detecting a first event log associated with a first network component of an open-radio access network (O-RAN);
generating a first digest associated with the first event log;
applying a first encryption key on the first digest associated with the first event log;
generating a first encrypted digest from the first digest based on the application of the first encryption key on the first digest;
generating first log information associated with the first network component, based on the first event log and the first encrypted digest;
transmitting the first log information to a service management component of the O-RAN,
the service management component is configured to validate, based on the first encrypted digest, an authenticity of the first event log; and
controlling a first display device to render the first log information based on the authenticity of the first event log.
